(19) United States
(12) Patent Application Publication
(10) Pub. No.: US 2003/0137979 A1
(43) Pub. Date: Jul. 24, 2003

(54) Switching unit

(76) Inventors: Ralph Hayon, Riverdale, NJ (US); Opher Yaron, Tel Aviv (IL); Tal Weiss, Nes-Ziona (IL)

Correspondence Address: BROWDY AND NEIMARK, P.L.L.C., 624 NINTH STREET, NW, SUITE 300, WASHINGTON, DC, 20001-5303, US

(21) Appl. No.: 10/203,182

(22) PCT Filed: Feb. 7, 2001
(86) PCT No.: PCT/IL01/00125

(30) Foreign Application Priority Data
Feb. 7, 2000 (IL) 134424

(51) Int. Cl. H04L 12/28; H04B 7/212

(52) U.S. Cl. 370/392; 370/444

(57) ABSTRACT

A switching unit that includes a number of input/output (I/O) ports and a processing module. The I/O ports include a number of distinct I/O ports and a like number of data network ports. The distinct I/O ports are associated, through the processing module to each other and are further associated, each, through the processing module to a corresponding data network port. The processing module is configured to process traffic arriving at one of the distinct I/O ports to which the traffic should be forwarded. The processor is further configured to forward other traffic arriving at one of the distinct I/O ports to the corresponding data network port, and to forward traffic arriving form one of the data network ports to a corresponding distinct I/O port

### FIELD OF THE INVENTION

The present invention relates to a switching apparatus and method for use in data communication networks and, in particular to a simple switching unit for adapting data communication networks to introduce Quality of Service (QoS) mechanism to support voice traffic over networks that were not designed for it.

### BACKGROUND TO THE INVENTION

In ordinary data networks, in particular local area networks (LANs) using Ethernet, the network infrastructure is built using equipment such as hubs and switches which link terminals to a central network backbone, thereby allowing the terminals to communicate with each other by some direct or indirect link, dependent on the network topology. Data is transmitted across networks as a series of packets. Packets are generated by a source such as a terminal or server attached to a port of a hub or switch and are, for example, transmitted individually across the network to a destination. As it is transmitted, each packet is given a destination address in a header field. When a data packet arrives at a hub it is duplicated to all ports of the hub and is therefore received by all terminals attached to that hub in addition to other linked hubs. If a terminal attached to a hub matches a received packet's destination address it accepts it, otherwise the packet is discarded. Unlike hubs, switches examine each data packet received and process it accordingly instead of duplicating the packet to each port. Switches map the addresses of attached terminals and then allow only necessary traffic to pass through the switch. Switches therefore allow the network backbone (known as the network of one or more high-speed links between hubs and switches) to be partitioned such that local traffic can be retained within a single switch whereas more distant traffic is transmitted from one switch to another that then passes it on to the destination. Switches can also connect different network types by acting as a form of gateway.

A switch commonly includes at least 2 I/O ports and at least one processor. Whilst there can physically be separate input and output ports for each terminal or link these are commonly shown as one port. Each port has a corresponding queue in a memory wherein packets received from or to be transmitted to the port are held. Packets arriving at an input queue of a switch wait in turn for a processor to determine the correct output queue, if any, before being forwarded to that queue. Unfortunately, switches tend to be very heavily loaded with traffic and a switch that outputs to a heavily loaded link (such as one connected to a server or another segment of a network) can induce some delay before processed packets can actually be put onto the link. Furthermore, switches tend only to have a limited storage space for queues and if a packet arrives at a switching device with a full input queue it will not be accepted and is normally discarded. The intrinsic nature of most ordinary data networks is that one terminal communicates with another via a server. In most cases, a terminal does not know the network address of another terminal and relies on the server having the information to forward correctly packets. This often means that the port(s) used by the server is (are) the most engaged and consequently, bring about delays and/or loss of packet(s) problems in such common networks.

Whilst data applications such as file transfer and general network communications are insensitive to delay and packet loss due to their abilities to identify lost packets and retransmit them, some data types, in particular multimedia data, are particularly sensitive to packet loss. When carrying streamed multimedia data over an Ethernet LAN, an analogue signal is quantized, packed into packets and delivered to the network. Received packets are then collected at the receiving side and the quantized information is used to reconstruct the original analogue signal. Almost all current applications attempt to regenerate the quantized streams in the order that they are received so that the received signal is displayed (video) or heard (audio) in as close to real-time as possible. Therefore, packets that are received out of order cannot be utilized and must be rejected. This continuous nature of streaming data makes it very sensitive to delay and also prevents the use of retransmission mechanisms to deal with the loss of packets. Many attempts to solve these problems have been made both at the computer software application level and also at the network packet transmission level. Data transmission protocols such as ATM (Asynchronous Transfer Mode—broadband switching and transmission technology) and Ethernet have introduced forms of Quality Of Service (QoS) mechanisms wherein data packets requiring special treatment can be marked in some way and have prioritized passage through the network infrastructure. The Ethernet Class of Service (CoS) mechanism for tagging packets is specified in the IEEE 802.1p draft standard. In this priority-based standard, 3 bits in the header of an Ethernet packet are used to identify one of 8 different levels of priority for the packet. In this manner, prioritized packets are able to queue-jump, thereby avoiding congestion at heavily loaded servers or full input queues.

Another CoS mechanism is the Type of Service (ToS) which was defined in the early 1980s as part of the TCP/IP header and was widely unused until recent IP traffic bottlenecks at the boundary routers required prioritization for better service levels. This mechanism is also priority based and inserts 3 Precedence bits in the Layer 3 header, which specifies 8 different priorities.

An advanced architecture that uses the ToS field is Differentiated Services (DS), which is a Policy/Rule based mechanism, backward compatible with the original use of the ToS field.

In FIG. 1 a scenario is schematically represented for a common situation wherein LAN telephony devices are utilized for voice communication using an existing network. LAN telephone devices introduced to the TCP/IP based network a family of new protocols called Voice over IP (VoIP), one example is the ITU-T H.323 standard. A multitude of devices and/or terminals is commonly connected to Ethernet switch/hub 100. PC 101 is connected via IP telephone 102 to I/O port 103 of switch/hub 100. In a similar way PC 104 is connected to I/O port 105 and multimedia-enabled PC 106 is connected to I/O port 107. Furthermore, IP telephone 112 is connected to I/O port 113 of Ethernet switch/hub 100. A media-enabled PC 111 and PC 114 are connected to Ethernet switch/hub 109. Interconnecting link (commonly known per se as a “downlink”) 108 connects Ethernet switch/hub 109 with Ethernet switch/hub 100. Multimedia-enabled PC 111 and PC 114 are connected to Ethernet switch/hub 109 and thus communicate with above-mentioned devices connected to Ethernet switch/hub 100.

Prior art has introduced several solutions to the above-described problem.

A. Upgrading existing networks with switching devices, supporting QoS in accordance with IEEE 802.1p.

By upgrading (replacing) Ethernet switch/hub 100 by a similar Ethernet switch/hub that provides priority based services in accordance with IEEE 801.1p, IP telephone 112 is able to voice communicate with IP telephone 102. Furthermore, any streaming multimedia-enabled device, such as PC 106 is equally provided with QoS to communicate with any other streaming multimedia-enabled device or IP telephone connected to the upgraded Ethernet switch/hub 100.

It is noted that non-compliant IEEE 801.1p Ethernet switches/hubs are relative “dumb” devices in the network infrastructure and have to be replaced or upgraded since they are unable to identify the new priority field in the header of a packet and consequently to provide prioritized passage services to marked packets. Replacing/upgrading such “dumb” devices with more “intelligent” ones is under normal circumstances a significantly expensive solution.

It is noted that the replacement of Ethernet switch/hub 100 has substantially alleviated QoS problems at Ethernet switch 100. However, there exists still a bottleneck situation between Ethernet switch/hub 100 and Ethernet switch/hub 109 as all traffic between both Ethernet switches/hubs 100 and 109 has to go through downlink 108.

B. Replacing interconnecting downlinks between Ethernet switches/hubs by higher throughput connections, such as Gigabit Ethernet connections.

Utilizing this method, the higher throughput obviates priority services as no substantial queuing occurs. It should be mentioned here that as well as being an expensive solution, many Ethernet switches/hubs do not support Gigabit Ethernet and have to be upgraded/replaced as well, making this option even more expensive. Secondly, this solution has inherent problems as any substantial network traffic will, regardless of higher throughput, result in packet losses and thus only relatively low traffic densities will enable concurrent QoS traffic. Therefore, significant over-provision in downlink capacity must be provided at all times, making this solution furthermore problematic from a network traffic aspect, besides significant costs of downlinks, having most of the time redundant over-capacity.

In order to support VoIP services at a toll quality voice standard, downlink 108 is replaced by a Gigabit Ethernet link, thus providing higher throughput. This replacement/upgrade provides media-enabled PC 111, connected to Ethernet switch/hub 109 with improved bandwidth. In addition to being substantially expensive, upgrading downlink 108 to a Gigabit link, usually brings about sine qua non, an upgrade of Ethernet switches/hubs 100 and/or 109, as many such non-compliant Ethernet switches/hubs do not support Gigabit Ethernet, inducing further substantial costs.

It should be noted that the replacement of downlink 108 by a downlink, supporting improved throughput, substantially alleviates QoS problems at downlink 108. However, notwithstanding upgrading/replacing both Ethernet switches/hubs 100 and 109 and downlink 108, bottleneck situations remain or are created now at specifically, ports 115 and 116, entrance of downlink 108 to respectively Ethernet switch/hub 100 and Ethernet switch/hub 109.

C. Adding additional switches or/and hubs, supporting QoS, for connecting QoS demanding terminals, devices and existing Ethernet switches and/or hubs.

Turning to FIG. 2 there is shown schematically the same topology as shown in FIG. 1, but wherein the existing network is extended as described now. To accommodate additional devices and/or terminals an additional QoS compliant Ethernet switch/hub 213 is connected to switch/hub 200 (100 in FIG. 1) by means of link 214 to a free port 215 at Ethernet switch/hub 200. Additional Ethernet switch/hub 213 provides the means to connect additional terminals and devices to the network. Thus, IP telephone 216 and IP telephone 217 are via Ethernet switch/hub 213 connected to the network. Furthermore, PC 218 is connected via IP telephone 216 and via Ethernet switch/hub 213 to the network. In addition, media-enabled PC 219 is connected to Ethernet switch/hub 213 as well. Those versed in the art will readily notice that port 215 has thus become the consolidated entrance port of all devices and terminals (in this scenario, 216, 217, 218 and 219) connected via Ethernet switch/hub 213 to the network. It is noted that commonly, a significant larger volume of traffic from devices, terminals and switches or/and hubs need to be forwarded through port 215 in order to access devices, terminals, etc. connected to Ethernet switches/hubs 200 and/or 209, creating a significant bottleneck, adverse affecting the throughput. Using a second, parallel downlink 220 between Ethernet switch/hub 213 and Ethernet switch/hub 200 via port 221 (known per se as trunk method) alleviates traffic congestion at port 215 by dividing the traffic between port 215 and port 221. However this solution is costly and creates further predicaments regarding scalability, not expanded upon here.

It should be noted that in order for utilizing above-mentioned trunking method, both Ethernet switch/hub 200 and 213 need to be trunk-compliant, adding additional expenses, as such switches are generally more expensive than non trunk-compliant Ethernet switches/hubs.

WO-A-99 65196 to Merlot Communications, Inc discloses a local area network (32) adapted for packet switching of standard Ethernet packets employing a communication switching module (44) to control flow of both delay-sensitive voice digital voice signals from digital telephones (36,38, 40, 42) and non-delay-sensitive user data from PC's (14, 16) and devices (18, 20) over 10 Base-T (or 100 Base TX) LAN segments (34). UTE adapters (46,48, 50) at user stations are connected to both voice and data devices, The UTE adapters and the communications switching module both incorporate a segmentation and reassembly (SAR) means (66). The SAR means on the transmitting end of the LAN segment segments synchronous digital voice and asynchronous data and encapsulates the segments into master Ethernet packets of fixed length, and transmits the master Ethernet packets at a constant fixed rate. The SAR means on the receiving end of the LAN segment extracts the segments and reassembles the segments into synchronous voice and asynchronous data packets.

WO-A-97 24841 to Cisco Systems, Inc. discloses a method and apparatus for an enhanced datagram packet switched computer network. The invention processes network datagram packets in network devices as separate flows, based on the source-destination address pair contained in the datagram packet itself. As a result, the network can control and manage each flow of datagrams in a segregated fashion. The processing steps that can be specified for each flow include traffic management, flow controls packet forwarding, access control and other network management functions.

The above description has thus shown that prior art has not provided solutions that encompass satisfying significantly all QoS requirements at the same time or/and moreover, at moderate costs.

Accordingly there is a need in the art to provide an appreciable simple and inexpensive solution that obviates the need to upgrade each and every switch hub and/or downlink, whilst QoS is nevertheless, achieved.

### SUMMARY OF THE INVENTION

It should be noted that in the context of the invention, the term “forwarding” of traffic is used to indicate that substantially no significant processing is performed on the traffic, since the traffic is transferred directly to a corresponding port, obviating the need to analyze the traffic's destination address. The term “processing” of traffic is used to indicate that the traffic is processed at least to review the destination address thereof and in response thereto, to determine the port to which the traffic is to be forwarded. Furthermore, the switching unit in accordance with the present invention demands only the learning of destination addresses of those multimedia-enabled devices or terminals connected to distinct I/O ports of the switching unit of the present invention, representing a significantly small percentage of all destinations in the network. Consequently, all packets with other destinations are merely forwarded, which as mentioned above, is a substantially simple and thus significantly fast process.

Traffic is, typically, a sequence of data packets.

According to one aspect of the present invention there is provided: a switching unit that includes a number of input/output (I/O) ports and a processing module; the I/O ports include a number of distinct I/O ports and a like number of data network ports; the distinct I/O ports are associated, through said processing module to each other and are further associated, each, through said processing module to a corresponding data network port; wherein the processing module is configured at least:

(i) to process traffic arriving at one of said distinct I/O ports, that is of a predetermined type, and that requires forwarding directly to a distinct I/O port, to said distinct I/O port to which said traffic should be forwarded to;

(ii) to forward other traffic arriving at one of said distinct I/O ports to the corresponding data network port, and

(iii) to forward traffic arriving from one of the data network ports to a corresponding distinct I/O port.

In order to avoid the expense and the intrusive problems in replacing switching hardware with hardware capable of operating under the new Quality of Service (QoS) standards, the present invention permits existing network infrastructures to be adapted for priority forwarding of specific traffic types by placing a traffic processing switching unit in front of existing non-priority capable network devices, such as Ethernet switches and Ethernet hubs.

In operation, in accordance with a preferred embodiment, the processing module checks each incoming packet and if it is determined that the packet is of a predetermined type, such as e.g. voice, video or multimedia, the system forwards the traffic directly to the distinct I/O port. connected to the addressed recipient's device or terminal, instead of passing it onto the data network. Effectively, the present invention provides priority forwarding or priority handling capabilities in a transparent manner to non-priority capable network devices, such as switches and hubs. The present invention offers priority forwarding capabilities over and above those specified by IEEE 802.1p in that certain specified types of data are not even forwarded on to the data network, but are instead forwarded directly to the intended distinct I/O port, connected to the addressed recipient's device or terminal, thus avoiding substantially all delays associated with a known per se non-prioritizing compliant data network.

Normal data packets relating to non-prioritized network communications enter the switching unit of the present invention at a distinct I/O port (e.g. port No.6) and forwarded through the switching unit on to the data network via the corresponding data network port (in this example, No. 6, corresponding and associated with distinct I/O port No. 6), obviating the need to process the destination address of the specified packet. Those versed in the art will readily appreciate that by virtue of avoiding a significant processing of incoming data packets to determine the destination address thereof, delays and latency associated with transmitting multimedia or voice over a data network is reduced. Moreover, the method increases normal network performance by reducing the number of data packets that otherwise would have to pass through the data network. Additionally, the switching unit of the present invention can be configured using standard Ethernet 802.1p switching chips.

It should be noted that the switching unit of the invention complies with Ethernet standards.

Preferably, the processor is configured to determine the type of the traffic in dependence on its content. The content is determined for example, according to data-encoding formatting indices, forming part of the traffic content.

Predetermined traffic types such as inter alia, voice, video or multimedia are common. Predetermined traffic types are defined by, for example, settings within a header portion of the traffic.

By one embodiment, the processor prioritizes the forwarding of traffic having priority settings within its header.

In the event that the processor cannot determine the distinct I/O port to which traffic of a predetermined type is to be forwarded, the processor is configured to:

(i) forward and duplicate (flooding) the traffic to all distinct I/O ports, except the distinct I/O port at which traffic arrived, or

(ii) forward the traffic to the corresponding data network port.

In accordance with a specific embodiment, there is provided a switching unit of the kind specified, wherein the processor comprises:

(i) a first switch,

(ii) a second switch, connected to said first switch,

(iii) a third switch, connected to said first and said second switch,

(iv) a number of demultiplexers, each connected to one of said distinct I/O ports and to said first switch and said second switch, each said demultiplexer being configured to forward said traffic arriving at a distinct I/O port to said first switch on condition that said traffic is of a predetermined type and to said second switch on condition that said traffic is not of said predetermined type,

said first switch being operative to determine the destination address of said traffic forwarded from said demultiplexers and forward said traffic to a demultiplexer for forwarding to a distinct I/O port having the destination address, whilst

said second switch is operative to forward said traffic to said third switch;

said third switch being operative to forward the traffic onto the data network via said corresponding network port;

said third switch being operative to forward said traffic arriving at one of said network data ports to said first switch; and

said first switch being operative to forward the traffic to a multiplexer that is connected to the corresponding distinct I/O port, and therefrom to the distinct I/O port.

Preferably, the demultiplexers are of a field programmable gate array (FPGA) type. Those versed in the art will readily appreciate that other solutions such as e.g. microprocessors and supplementary software can equally be utilized.

The first and second switches are linked to a third switch via preferably, an internal high-speed bus, the third switch being furthermore connected to the data network.

Preferably, traffic arriving at one distinct I/O port addressed to another distinct I/O port of said distinct I/O ports and having priority settings, is forwarded to the addressed I/O port ahead of traffic having, lower or no priority settings. The network-connecting unit can be a switch or a hub.

There is further provided in accordance with another aspect of the invention: a data network including a switching unit that includes a number of terminals and a processing module; the processor module processing traffic arriving from said terminals in order to determine the destination address and the type of the traffic, the processor being configured at least:

(i) to process traffic that is of a predetermined type and that is addressed to one of said terminals and forward it directly to the terminal, and

(ii) to forward other traffic arriving at one terminal onto a corresponding data network terminal.

Still further, there is provided in accordance with the invention: in a switching unit connecting a number of distinct I/O ports to a data network, a method for forwarding of traffic in a prioritized manner, comprising the steps of:

(a) processing the traffic arriving at one of said distinct I/O ports to determine its type;

(b) comparing the type of said traffic with a number of predetermined types representative of prioritized handling;

(c) processing said traffic, having one of said predetermined types, to determine its destination address;

(d) forwarding said traffic, having one of said predetermined types, having a destination address matching one of a distinct I/O ports, to said distinct I/O port; and

(e) forwarding traffic not of one of the predetermined types onto a corresponding data network port.

Preferably, the method further comprises the step of forwarding traffic arriving from the data network at one of the said network ports to the corresponding distinct I/O port.

By one embodiment, the determination of traffic type in step a) is performed in dependence on the content of said traffic. By another embodiment, the determination of traffic type in step a) is performed in dependence on settings within a header portion of the traffic.

Preferably, forwarding of traffic of one of a predetermined type is prioritized ahead of forwarding of other traffic.

By one embodiment, there is further provided the step of forwarding traffic of one of a predetermined type not having a destination address matching one of said distinct I/O ports to all of said distinct I/O ports except for the distinct I/O port to which the traffic arrived.

By another embodiment, there is further provided the step of forwarding traffic of one of a predetermined type not having a destination address matching one of said I/O ports onto the data network via the corresponding network port.

### BRIEF DESCRIPTION OF THE DRAWINGS

An example of the present invention will now be described by way of non-limiting example only in detail with reference to the accompanying drawings, wherein:

FIG. 1 is a schematic diagram of a common data communication network in accordance with the prior art, wherein voice communication devices are being introduced;

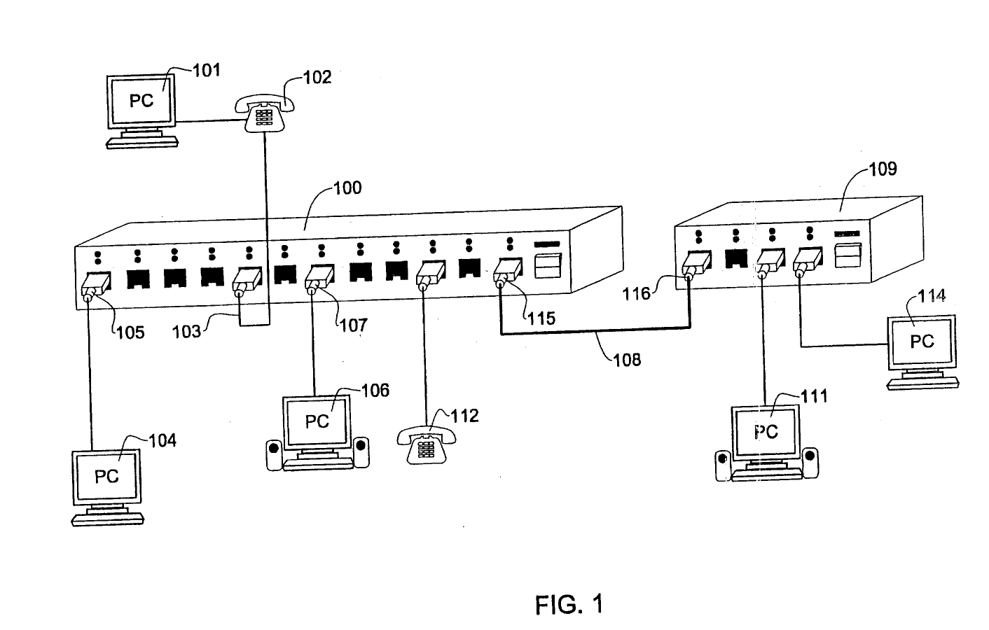

FIG. 2 is a schematic diagram of the data communication network as depicted in FIG. 1, with additional streaming media terminals, requiring QoS, accordingly to prior art;

FIG. 3 is a schematic diagram of a data communication network incorporating the switching unit of the present invention;

FIG. 4 is the schematic diagram of FIG. 3 showing the switching of prioritized and non-prioritized data traffic;

FIG. 5 is a flowchart showing the switching algorithm of the switching unit in accordance with the present invention;

FIG. 6 is the schematic diagram of FIG. 3 showing the switching of prioritized data traffic via a gateway and a PSTN, whilst simultaneously switching non-prioritized data to and from the network;

FIG. 7 is the schematic diagram of FIG. 3 showing the connection of two switching units according to the present invention;

FIG. 8 is the schematic diagram of FIG. 3 showing the connection of two switching units according to the present invention at distant locations;

FIG. 9 is a schematic diagram showing a method of accomplishing a virtual larger switching unit in accordance with the present invention;

FIG. 10 is a schematic diagram of the hardware components of a basic switching unit in accordance with the present invention;

FIG. 11 is a schematic diagram showing the switching of prioritized data in accordance with a preferred embodiment;

FIG. 12 is a schematic diagram showing the switching of non-prioritized data in accordance with a preferred embodiment; and

FIG. 13 is a schematic diagram showing the switching of data from the network in accordance with a preferred embodiment.

### DETAILED DESCRIPTION OF PREFERRED EMBODIMENTS

For convenience of explanation, the description below relates to Ethernet switches and Ethernet hubs. It should be noted that the invention likewise applies to other known switching devices, including bridges.

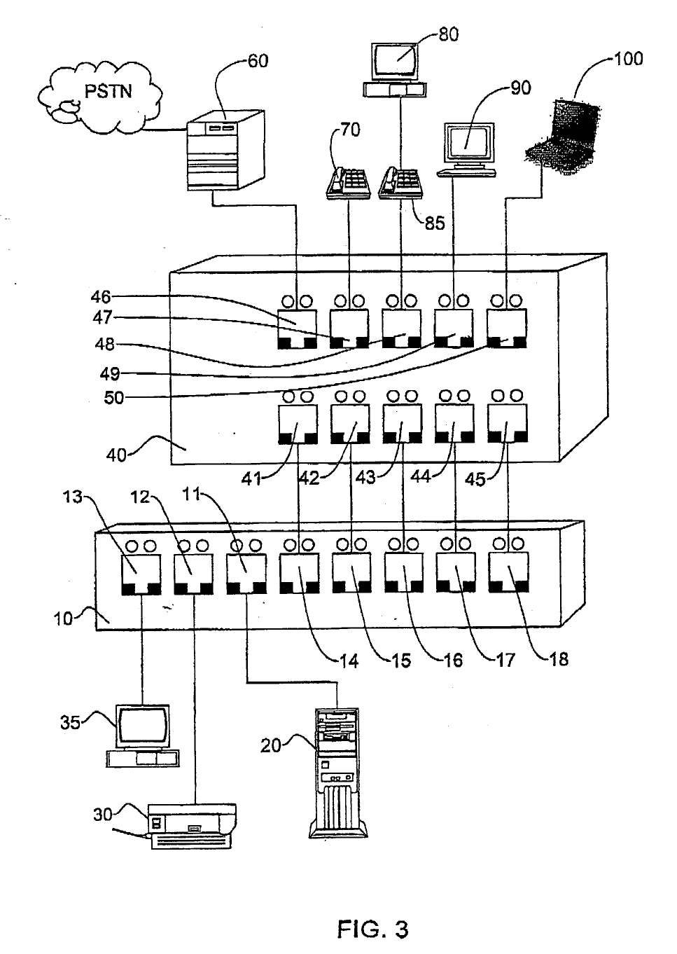

FIG. 3 is a schematic diagram of a common data communication network incorporating the switching unit of the present invention. An Ethernet switch 10 has ports 11, 12 and 13 connected respectively to a LAN server 20, a networked printer 30 and a computer terminal 35. These components are standard for a non-prioritized data network. The remaining ports 14-18 of switch 10 are connected to corresponding network ports 41-45 of a switching unit 40 operating in accordance with the present invention. Each network port 41-45 of the switching unit is corresponding with a distinct I/O port 46-50 to which terminals (a gateway 60, an IP telephone 70, a PC 80 (via IP telephone 85), and two computer workstations 90 and 100 are connected.

When a data packet is transmitted to one of the distinct I/O ports 46-50 from one of the terminals 60-100, the switching unit 40 examines the data packet to determine its type and if the destination address is known in accordance with an embodiment further below described in more detail.

(A) If the data packet is a normal network data packet relating to client-server communications or the like, the data packet is forwarded to the corresponding network port 41-45 corresponding to the distinct I/O port at which the packet was received. As and when the switch 10 can accept the data packet in its input queue, the data packet is forwarded from network ports 41-45 of switching unit 40 to the corresponding connected ports 14-18 of switch 10 and then at some point on to its destination. If the data packet has a priority label in its header field, representative of QoS required handling, the prioritized packet is forwarded by switching unit 40 with appropriate prioritization.

(B) If switching unit 40 determines that a data packet received at a distinct I/O port 46-50 satisfies one or more of a number of predetermined criteria, it accesses the address held in the data packet's header. If switching unit 40 recognizes the address as the address of one of the terminals 60-100, being connected to one of the distinct I/O port 46-50, the data packet is forwarded to that appropriate distinct I/O port 46-50. If the address is unknown, switching unit 40 is configured either:

(a) to transmit the data packet to all distinct I/O ports 46-50, except for that from which it was initially received (known as “flooding”), or

(b) to forward the packet via the corresponding network port onto the data network for known per se switching.

It should be noted that whilst in the description each port is connected to a single device or terminal, those versed in the art will thus readily appreciate that the invention is by no means bound by this particular example, thus in an alternative embodiment, one or more of the specified ports is connected to more than one devices or terminals.

There follows a few common scenarios of the switching method of the apparatus in accordance with the present invention. Those versed in the art will readily appreciate that numerous other configurations, applications, architectures and scenarios are conceivable without departing from the scope of the present invention.

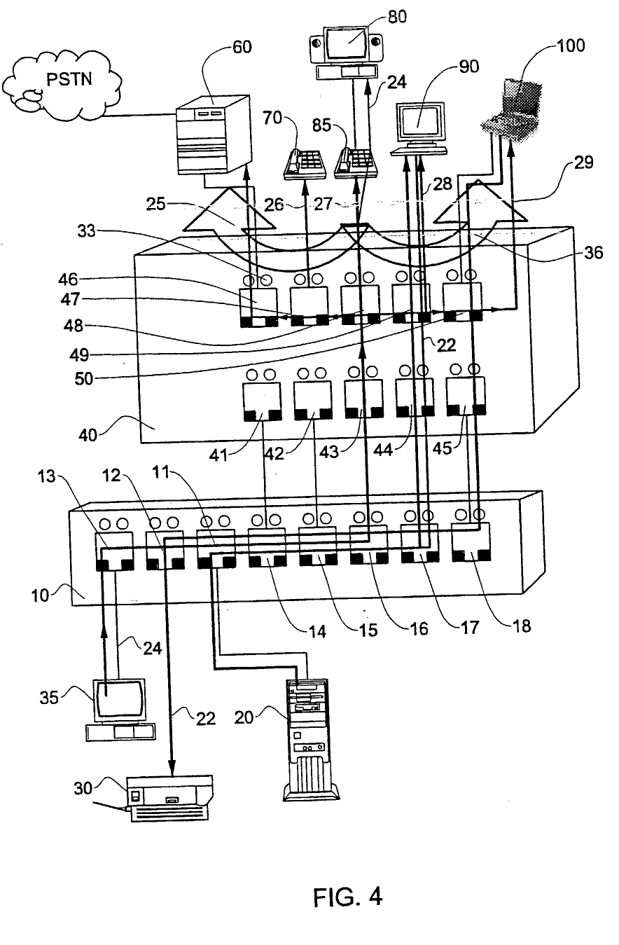

FIG. 4 is the schematic diagram of FIG. 3 showing the switching of data traffic.

The addresses of terminals and other devices connected to Ethernet switch 10 via switching unit 40 are, by one embodiment, dynamically learned by Ethernet switch 10 in accordance with standard Ethernet switching routines. In this manner, Ethernet switch 10 maps port 14 to gateway 60, port 15 to IP telephone 70 and so forth. Data packets forwarded from terminals or devices of the non-prioritized data network 20, 30, 35 are addressed to terminals 60-100 using the addresses mapped to the ports of Ethernet switch 10. Therefore a packet addressed to terminal 90 is forwarded by Ethernet switch 10 to port 17 which then passes it on to the corresponding network port 44 of switching unit 40, which in turn passes the data packet on to corresponding distinct I/O port 49 for receipt by the terminal 90.

In the occurrence that Ethernet switch 10 has no knowledge of the destination port, Ethernet switch 10 will flood all ports, thus, ports 14 until 18 will be flooded, consequently, data network ports of switching unit 40 are flooded. It should be noted that switching unit 40 is transparent in its operations and therefore all terminals and devices connected to switching unit 40 via distinct I/O ports 46-50 all receive the packets in the same manner as if the devices or terminals had been connected directly to Ethernet switch 10 in accordance with prior art.

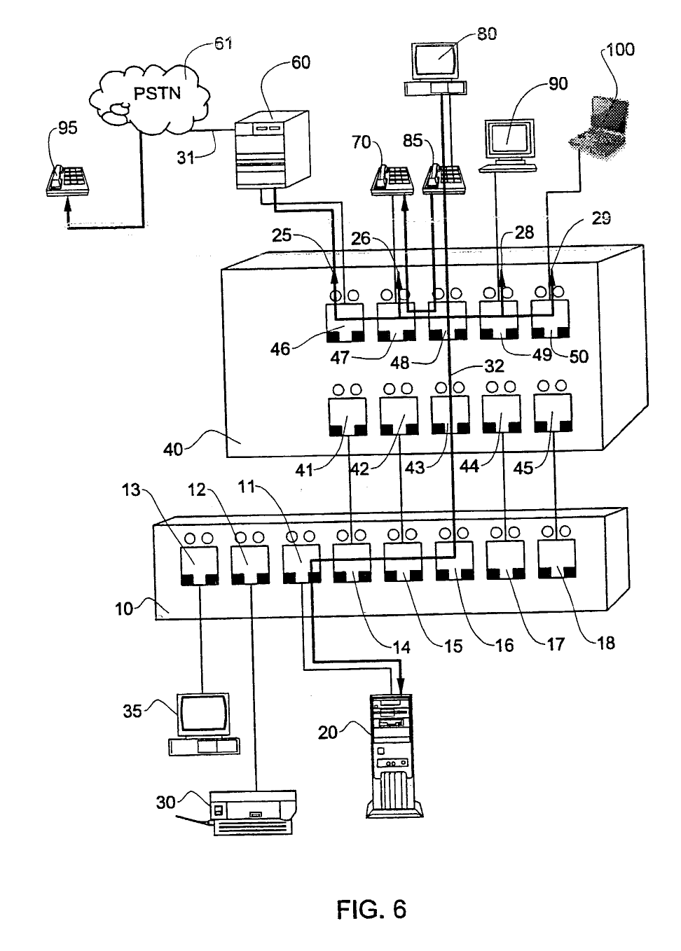

In FIG. 6, IP telephone 85 connected to distinct I/O port 48 of switching unit 40, initiates a voice communication session with IP telephone 70, connected to distinct I/O port 47 of switching unit 40. Upon arrival, switching unit 40 identifies the packet as requiring QoS and moreover, identifies the destination terminal or destination device as being connected to distinct I/O port 47. Therefore, switching unit 40 forwards the packet directly (indicated by arrowhead 26) to distinct I/O port 47, to which IP telephone 70 is connected.

Another scenario would be a voice call from IP telephone 85 to a PSTN subscriber 95. Upon receipt of the data packet, switching unit 40, in case it does not recognize the address, will in accordance with the present invention, flood all distinct I/O ports with copies of the data packet (indicated by arrowheads 25, 26, 28, 29), except port 48, being the originating port. Gateway 60 connected to distinct I/O port 46 recognizes the destination and thus will accept the data packet. In case switching unit 40 recognizes the address, the packet is immediately forwarded (indicated by large arrow 33, see FIG. 4) to distinct I/O port 46. Via link 31 and PSTN 61 subscriber 95, using a POTS (Plain Old Telephone System), receives the reconstructed analog signal and picks up the telephone and establishes thus the telephone communication between him and his associate, who is using IP telephone 85.

Whilst holding above-mentioned telephone conversation, the user of IP telephone 85 is also working on his PC 80 and needs to access files on the network server 20. Thus, a data packet, originating from PC 80 is transmitted via IP telephone 85 to distinct I/O port 48 of switching unit 40. Upon processing the data packet, switching unit 40 determines that it does not satisfy any of the set of predetermined criteria for priority forwarding and the data packet is therefore forwarded to queue at corresponding network port 43 for insertion onto the data network as is indicated by arrowhead 32. Ethernet switch 10 switches the data packet received at corresponding port 16 to port 11, being connected to the destination device, server 20.

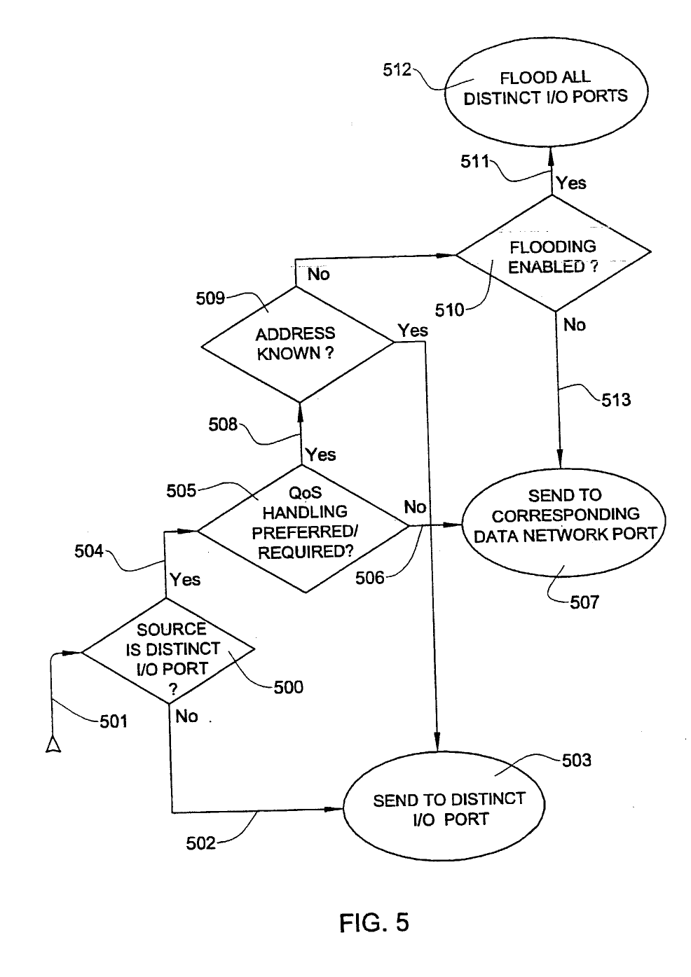

There follows now a brief description with reference to FIG. 5, of the algorithm utilized by the processor of the present invention.

A flow chart of the processing procedure of the present invention is shown. From a processor algorithm perspective, the first decision 500 is to establish the source of the presently arrived packet 501. If the present packet did not arrive from one of the distinct I/O ports (hence arriving from the data network via one of the data network ports), the packet is forwarded 502 to the corresponding distinct I/O port 503. Otherwise 504, the decision 505 has to be made if QoS handling is preferred. If not, then the packet is forwarded 506 to the corresponding data network port 507. Otherwise 508, the processor queries 509 the destination address of the present packet. If the destination address is not known, denoting one of the distinct I/O ports of the switching unit, it queries its configuration settings or hardwired instruction set to determine if flooding is enabled 510. If affirmative 511, flooding of all distinct I/O ports (except the distinct I/O port at which the data packet arrived from) is executed 512. If configured otherwise 513, the present packet is forwarded to the corresponding data network port 507. Returning now to destination decision 509, if the destination terminal or device is known to be connected to one of the distinct I/O ports of the switching unit of the present invention, the present packet is forwarded 514 to the corresponding distinct I/O port 503, unless it is the same distinct I/O port at which the data packet arrived from, in which case it is discarded.

Returning to FIG. 4, arrrowhead line 24 shows the route of a non-prioritized data packet originating from the data network (more specifically, from PC 35). A data packet is transmitted to port 13 of Ethernet switch 10. Ethernet switch 10 switches the data packet to port 16, having in its mapping data the address of the destination (multimedia-enabled computer 80) as being connected to port 16. Port 16 is connected to switching unit 40 via corresponding network port 43. Switching unit 40 forwards the packet to corresponding distinct I/O 48, connected to multimedia-enabled computer 80 via IP telephone 85.

In another scenario, from media-enabled computer 80, a prioritized data packet is transmitted, having an address, held in the data packet's header that is not recognized by the switching unit 40. Therefore switching unit 40, dependent upon its configuration, can “flood” all distinct I/O ports 46-50, indicated by arrowheads 25, 26, 28, and 29. As mentioned-above, distinct I/O port 48 is not flooded, on account of being the originator. The packet is accepted by computer 100 (being the addressed recipient), connected to distinct I/O port 50. Notwithstanding flooding, QoS (Quality of Service) is maintained, at least from network port 48 until destination. In the event that switching unit 40 is capable of identifying the address, the packet is immediately forwarded to distinct I/O port 50 (indicated by large arrow 36) from where it arrives at computer 100.

An arrowhead line 22 shows the route of a non-prioritized data packet to the data network. The data packet is transmitted from a terminal 90 to the distinct I/O port 49. Upon processing the data packet, switching unit 40 determines that it does not satisfy any of the set of predetermined criteria for priority forwarding and the data packet is therefore forwarded to queue at corresponding network port 44 for insertion onto the data network.

The data packet is transferred from network port 44 to corresponding port 17 of the Ethernet switch 10. Ethernet switch 10 processes the packet and switches it to its destination (printer 30) via port 12, according to the destination address in the packet's header.

It should be noted that in the various embodiments of the switching unit of the present invention, with reference to the respective drawings, only 5 distinct I/O ports and consequently, only 5 corresponding data network ports are depicted. Furthermore, the confinement to this specific number of paired/corresponding ports has been chosen to avoid complicated and thus less clear drawings. As will be discussed in more detail below, substantially, there are no limits to the number of paired/corresponding ports a switching unit of the present invention can comprise.

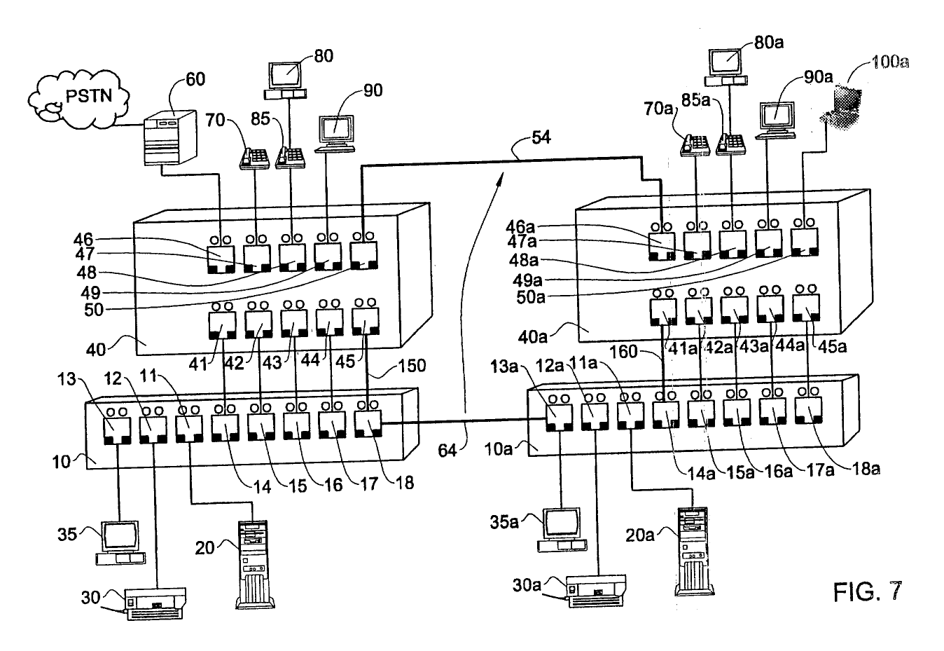

Turning now to FIG. 7, a LAN network topology, based on the same modules as described in reference to FIG. 3 is shown. The schematic diagram shows the connection or linking of two switching units according to the present invention, achieving a larger, virtual switching unit. Distinct I/O port 50 of switching unit 40 is connected to a distinct I/O port 46a of another switching unit 40a by link 54.

Those versed in the art will readily appreciate the possibility of using an existing downlink 64 between Ethernet switch/hub 10 and Ethernet switch/hub 10a (now dispensable) to establish link 54. It is noted here, that common network traffic, prior to installation of the switching unit of the present invention, would have been switched via port 18 of Ethernet switch/hub 10 and via downlink 64 to port 13a of Ethernet switch/hub 10a. Following the employment of the switching units of the present invention, downlink 64 is disconnected from Ethernet switch/hub 10 and Ethernet switch/hub 10a and put to use for link 54 between distinct I/O port 50 at switching unit 40 and distinct I/O port 46a of switching unit 40a. Ethernet switch/hub port 18 is connected with link 150 to network port 45 of switching unit 40, while an equivalent link 160 is made between network port 41a of switching unit 40a and port 14a of Ethernet switch/hub 10a.

Thus a downlink has been achieved equivalent in functionality as downlink 64 before, but in addition, switching unit 40 has now been extended with switching unit 40a, providing QoS to any device or terminal connected to distinct I/O ports 46, 47, 48, 49, 50, 46a, 47a, 48a, 49a, and 50a.

The addresses of terminals 70a-100a are mapped to distinct I/O port 50 of switching unit 40 and vice-versa, addresses of terminals 60-90 are mapped to distinct I/O port 46a of switching unit 40a, allowing prioritized and non-prioritized traffic to be relayed or forwarded between the two switching units 40 and 40a and processed in a manner as previously described. Those versed in the art will readily appreciate the utilization of a configuration in reference to FIG. 7 in ubiquitous LAN's (Local Area Networks). Prioritized data is thus switched between switching units 40 and 40a without reaching neither Ethernet switch/hub 10 nor Ethernet switch/hub 10a, whilst not requiring any extra wiring. Furthermore, all network traffic flowing between Ethernet switch/hub 10 and Ethernet switch/hub 10a will be forwarded through switching units 40 and 40a.

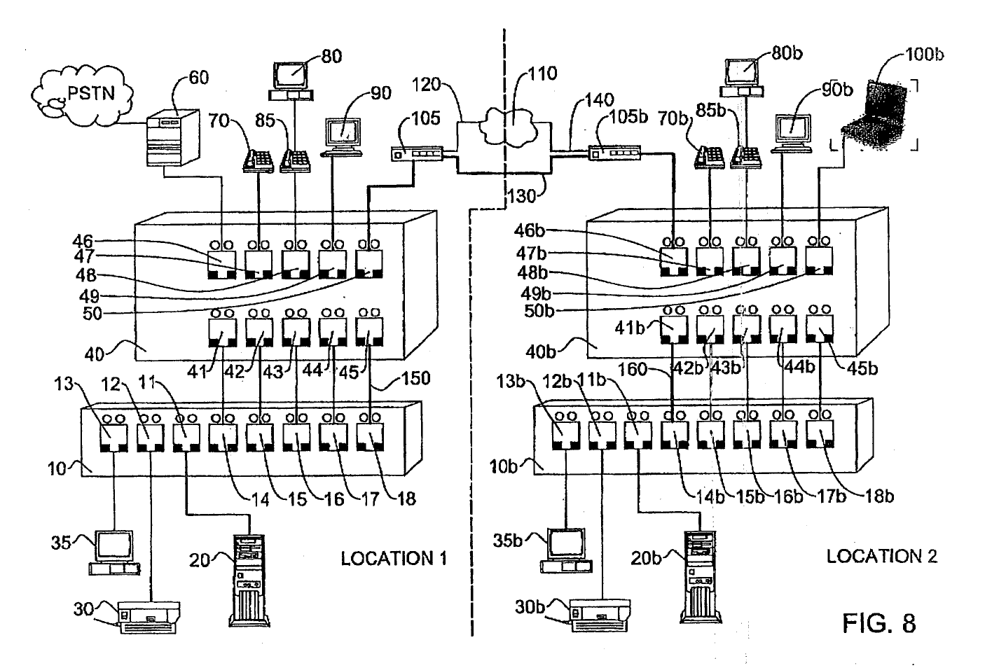

FIG. 8 shows a similar topology as shown in FIG. 7, wherein the connection or linking of two switching units according to the present invention is required between distant locations 1 and 2, prevalent in WAN (Wide Area Network), MAN (Metropolitan Area Network) and/or Internet networks. Similar to above-described downlink 150 and 160 method, distinct I/O port 50 of Ethernet switching unit 10 is connected to a router 105 which is in turn connected to:

(a) the Internet 110, via link 120 to an ISP (Internet Service Provider), or

(b) a WAN, utilizing e.g. a point-to-point link 130.

At another location, another router 105b connects between

(a) the Internet 110 via a link from an ISP 140, or

(b) a point-to-point link 130, and

a distinct I/O port 46b of another switching unit 40b. The processing of traffic occurs as has been described with reference to FIG. 7, but is forwarded across the Internet 110 or across point-to-point link 130 via routers 105 and 105b as and when necessary.

Those versed in the art will readily appreciate that above-described configuration with reference to FIG. 8 is essentially the same configuration as described with reference to FIG. 7, wherein either a direct link or an indirect link via one or more routers via the Internet or other communication network is utilized. Router 105b will thus connect to Ethernet switch/hub 10b through switching unit 40b, whilst router 105 will connect to Ethernet switch/hub 10 through switching unit 40. Both switching units 40 and 40b will prioritize traffic flowing to/from the WAN/Internet whilst maintaining QoS in as far as the LAN is concerned. It should be mentioned that in order to maintain QoS throughout the WAN/Internet, QoS enabled routers need to be utilized.

It is noted that the invention is by no means limited by above described preferred embodiments and numerous other configurations and topologies utilizing at least one switching unit in accordance with the present invention, are within the scope of the present invention.

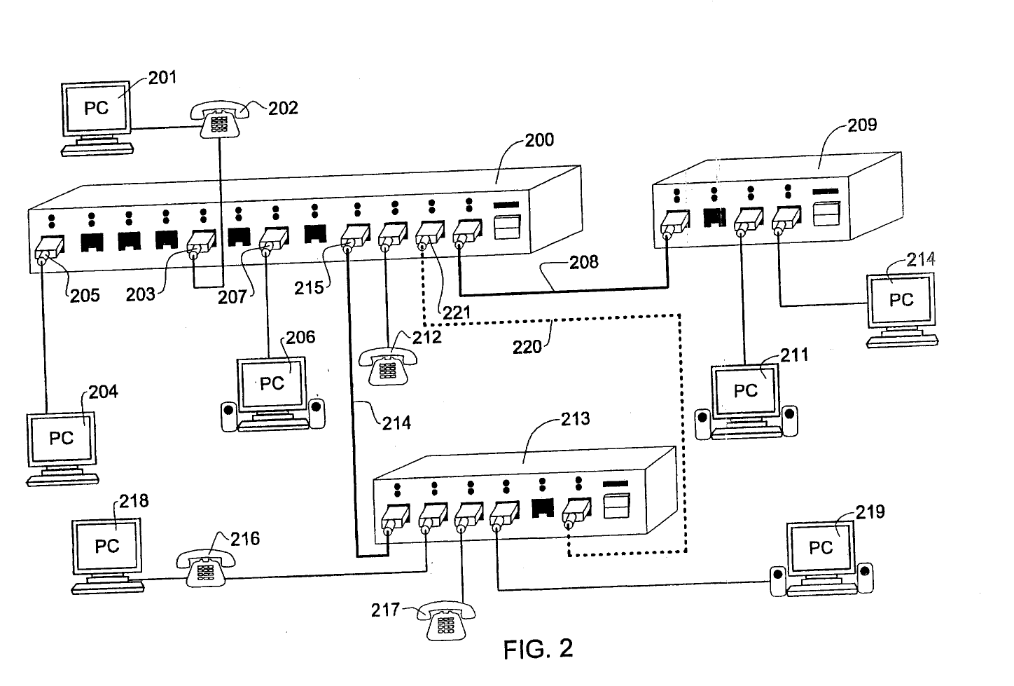

The switching unit of the present invention alleviates in addition most scalability predicaments described above with reference to FIG. 2.

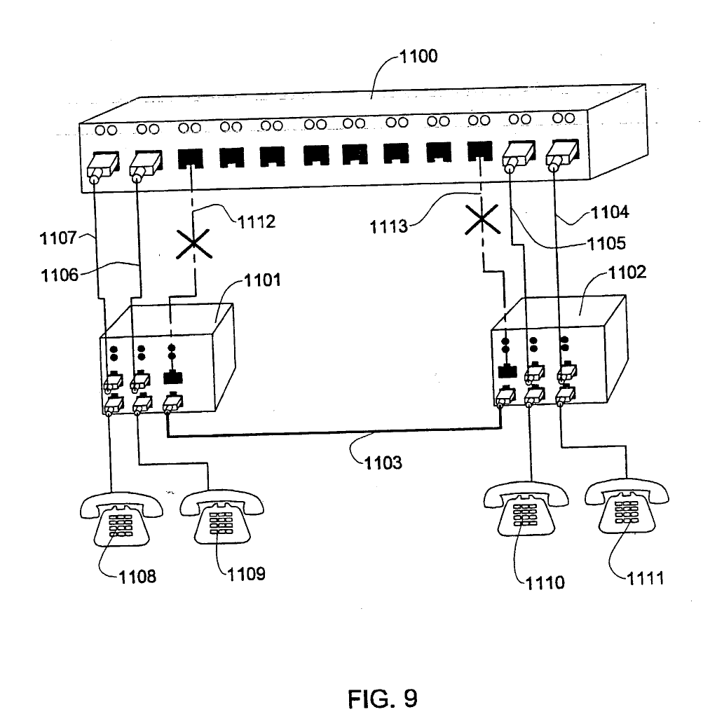

In FIG. 9 an Ethernet switch/hub 1100 is shown constituting a plurality of ports. Having described in FIG. 7 and FIG. 8 the achievement of larger, virtual switching units, there follows now another embodiment of the present invention, wherein a large Ethernet switch by means of the switching unit of the present invention is provided with QoS. It is noted that the switching unit of the present invention can be realized with a few ports and by linking multiple switching units of the present invention, substantially all ports of the large Ethernet switch can be provided with QoS. It is thus noted that linking switching units of the present invention accomplishes a virtual larger switching unit of the present invention, transparently operating as one singular larger switching unit. Switching unit 1102 is linked in a manner described above with reference to FIGS. 7 and 8 with switching unit 1101 by means of downlink 1103, but it should be noticed that in this embodiment connections 1112 and 1113 are not used to avoid a loop in the Ethernet topology. Ethernet switch/hub 1100 is connected to both switching units 1101 and 1102 by connections 1104, 1105, 1106 and 1107 via the data network ports of both switching units. Therefore, all corresponding distinct I/O ports and consequently, IP telephones 1108, 1109, 1110 and 1111, are thus individually associated with the ports of Ethernet switch/hub 1100 in a network-transparent manner.

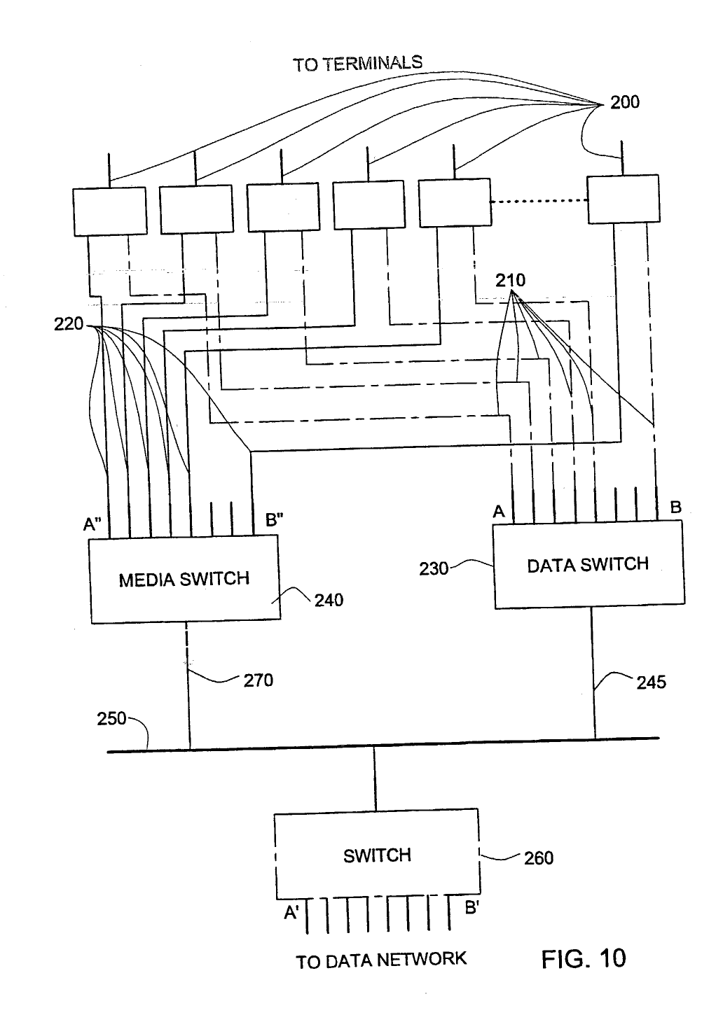

FIG. 10 is a schematic diagram of major hardware components of a switching unit according to the present invention, but those versed in the art will readily appreciate that a variety of diversified hardware components can be utilized to provide substantially similar results.

Each distinct I/O port is connected to a demultiplexer 200. Each demultiplexer 200 is preferably implemented by a field programmable gate array (FPGA). More preferably, all demultiplexers 200 are inside a single FPGA.

The multi demultiplexers 200 are configured to process each incoming packet and, if it satisfies a predetermined criterion, pass it via media path 220 to media switch 240. Otherwise, the packet is forwarded via data path 210 to data switch 230. Packets arriving at the media switch 240 from one of the multi demultiplexers 200 are processed to determine their destination address and sent back to the corresponding demultiplexer(s) 200 via media path 220. The corresponding demultiplexer 200 then passes the packet to the terminal. Packets arriving at the data switch 230 are forwarded onto preferably, internal high-speed bus 250 and then onto the corresponding data network via switch 260. The switches 230, 240 and 260 have their inputs and outputs matched (in a corresponding manner), such that a data packet arriving via data path 210 to input A of data switch 230 is eventually output onto the data network on output A′ of switch 260. Equally, packets arriving at input B of 230 are eventually output on B′ of 260.

Depending on the desired configuration, packets arriving at media switch 240 without a recognizable destination address are either forwarded onto the data network via link 270, internal high-speed bus 250 and switch 260 or are flooded back to all demultiplexers 200.

Packets arriving at switch 260 from the data network are forwarded to media switch 240 via the internal high-speed bus 250 and link 270. Media switch 240 then queues the packet on the corresponding port according to the port of switch 260 on which it was received and sends it to the corresponding demultiplexer 200 via data path 220 when no packets of higher priority are queued there for transmission. The I/O matching of switches 230, 240 and 260 described above also happens in reverse. In this manner, data packets arriving at input A′ of switch 260 are forwarded via links 250 and 270 to switch 240 and eventually output on A″ to the corresponding media path 220.

Whilst switches 230, 240 and 260 have different functionality respectively, they can be realized in practice by the same type of known per se semiconductor or chip. It is noted that switches 230, 240 and 260 can be realized utilizing known per se standard Ethernet 802.1p switching chips.

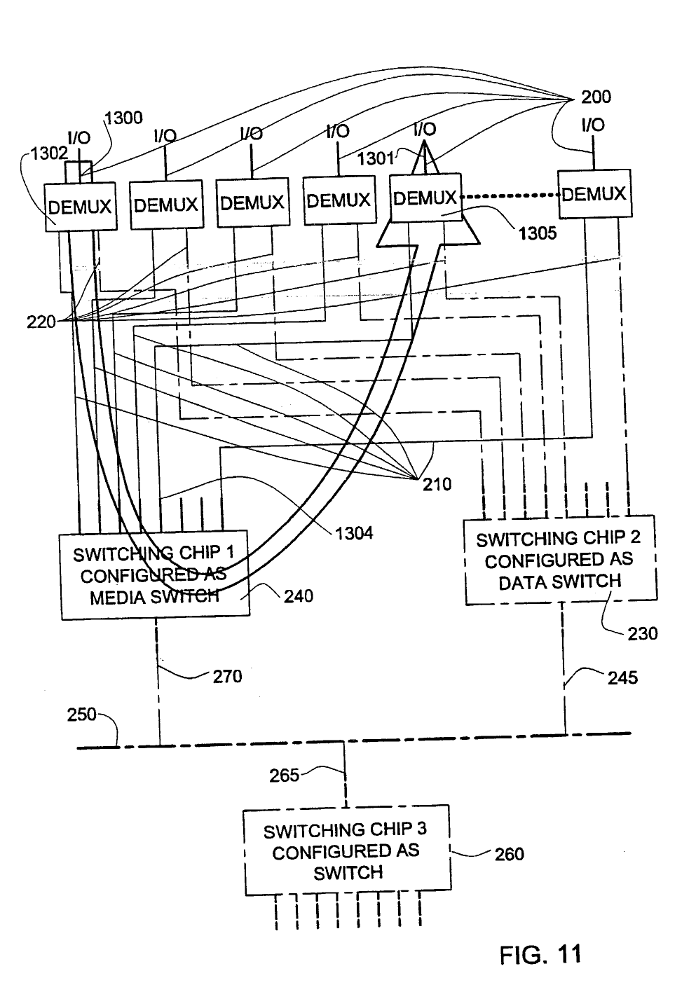

Turning now to FIG. 11 showing the infrastructure of the data paths as has been discussed above in reference with FIG. 10, but in addition, shows when and in which manner switches 230, 240 and 260 operate.

The first synopsis is the arrival of a QoS requiring/preferring data packet at distinct I/O port 1300. Furthermore, the destination address of the packet is a terminal/device connected to another distinct I/O port 1301 of the same switching unit of the present invention. Thus, in accordance with the present invention, described above in more detail, demultiplexer 1302 forwards the packet onto media path 210, in this case connection 1303, to switching chip 240, which forwards the packet via output 1304 to the corresponding distinct I/O port 1301 via demultiplexer 1305. The packet is then directly transmitted to the destination terminal/device, connected to distinct I/O port 1301.

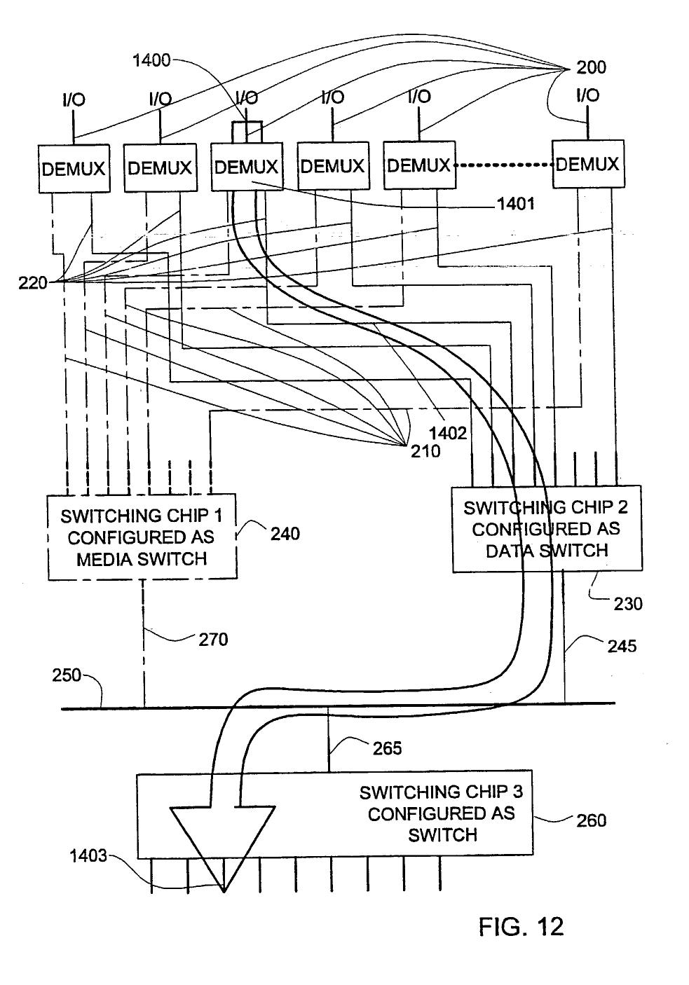

In FIG. 12 the second synopsis is shown, wherein a data packet, not satisfying a predetermined criterion arrives at distinct I/O port 1400. Thus, in accordance with the present invention, described above in more detail, demultiplexer 1401 forwards the packet onto data path 220, in this case connection 1402, to switching chip 230, which forwards the packet via output 245, onto, preferably, internal high-speed bus 250.

Switch 240 is configured not to accept any traffic from the internal high-speed bus 250 coming from a data switch such as 230 via connection 270, and is therefore in this synopsis inactive.

Switch 260, in contrast, is configured to accept traffic from a data switch such as switch 230 via the internal high-speed bus 250 and connection 265. Switch 260 forwards the packet via corresponding data network port 1403 onto the network. The packet is then transmitted to a destination terminal/device, via one or more switches/hubs in a known per se manner.

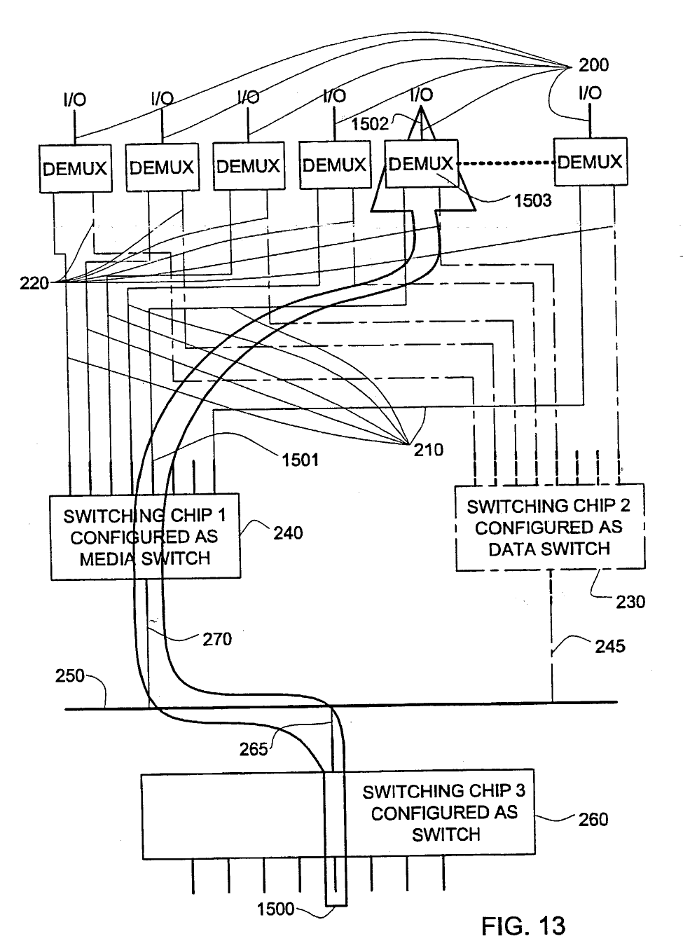

In FIG. 13 the third synopsis is shown, wherein a data packet arrives at data network port 1500. Thus, in accordance with the present invention, described above in more detail, switch 260 forwards the packet onto preferably, internal high-speed bus 250, via connection 265. Switch 230 is configured not to accept traffic from the internal high-speed bus 250 and is therefore in this synopsis inactive.

Switch 240, in contrast is configured to accept traffic from switch 260 via the internal high-speed bus 250 and connection 270. Switch 240 forwards the packet via output 1501 to the corresponding distinct I/O port 1502 via demultiplexer 1503 directly to the destination terminal/device, connected to distinct I/O port 1502.

As mentioned before, embodiments described above in reference with FIGS. 3, 7, 8, 9 and 10 are only a few out of many possible configurations and those versed in the art will readily appreciate that many other applications are conceivable and a multitude of modifications to the hardware of the present invention are possible without departing from the scope of the present invention. Thus, e.g. the above-mentioned internal high-speed bus/backbone can be realized by existing Gigabit links and if available, consequently, the high-speed bus/backbone is thus not confined to be an internal high-speed bus/backbone. Those versed in the art will readily appreciate that conceptually, no substantial change in manner of operation will take place.

The predetermined criterion that is used in the demultiplexers 200 to determine whether a data packet should be forwarded directly to its recipient terminal instead of via a data network is likely to vary from one network to another. One of the most likely criteria would be to recognize the contents of a packet as having a particular specified media type such as voice, video or multimedia. The protocol of the frame(s) within the packet is likely to be the best indicator of its contents, for instance the RTP protocol indicates media content.

Alternatively or in addition to the criterion mentioned above, a predetermined criterion can simply be flag settings within the header of a packet allowing the generating terminal to specify packets that should be forwarded via the data network and those that should not. Indeed, some or all of the priority label values discussed above that allow packets to queue-jump onto the data network can be used in addition to specify packets that should not be forwarded onto the data network at all.

It can simply be specified that packets addressed to certain addresses should always be forwarded directly to the port corresponding with that address. This type of criterion would be applicable to terminal types that never receive network data packets such as limited capability IP telephones.

A number of predetermined criteria and/or priority flag settings can be used in combination in order to further prioritize data packets that should be forwarded directly to the addressed recipient.

Furthermore, the switching unit in accordance with the present invention is capable of optionally, providing prioritized services also to data packets arriving from a network port.

It should be mentioned here that the present invention is by no means bound by the specific steps or decision making algorithms described above, and any method that utilizes the features of the present invention concerning the provision of QoS in a non-compliant QoS network by coupling a switching unit as described in the embodiments of the present invention, are within the scope of the present invention.

The present invention has been described with certain degree of particularity. Those versed in the art will readily appreciate that various modifications and alterations may be carried out without departing from the scope of the present invention. For example, whilst the present invention has been described as a separate component of equipment to be used in conjunction with existing Ethernet switches or/and Ethernet hubs, it is equally possible for a single unit to be manufactured, operating as a full Ethernet switch/hub, incorporating features of both pieces of equipment. Indeed, it is also possible for equipment according to the present invention to be used in conjunction with an Ethernet switch or Ethernet hub, enabling data network connectivity in a significantly independent unit. Furthermore, the present invention is not limited to Ethernet and could be applied to many other network types, including inter alia, token-ring.

1. A switching unit comprising:
a plurality of input/output (I/O) ports including a number of data network I/O ports and a like number of priority I/O ports; each data network port connectable to a network switching device external to the switching unit; and
a processing module, wherein each priority port is associated through said processing module with a different data network port and is further associated through said processing module with all other priority ports,
said processing module is configured to process a packet of a predetermined type representative of prioritized handling arriving at a priority port from outside the switching unit and to forward said packet to another priority port, provided said packet requires forwarding to said another priority port, and said processing module is configured to prioritize said packet over packets of types not representative of prioritized handling which are forwarded to said another priority port, and wherein said processing module is configured to forward a packet of a type not representative of prioritized handling arriving at a priority port from outside the switching unit to the associated data network port thereof, and said processing module is configured to forward a packet of any type arriving at a data network port from a connected external network switching device the associated priority port thereof.

2. A switching unit according to claim 1, wherein said processing module is configured to determine the type of a packet in dependence on content of said packet.

3. A switching unit according to claim 2, wherein said content is determined according to a data-encoding format of said packet.

4. A switching unit according to claim 1, wherein said processing module is configured to determine the type of a packet in dependence on settings within a header portion of said packet.

5. A switching unit according to any of the preceding claims, wherein said predetermined type representative of prioritized handling is at least one from: voice, video, and multi-media data.

6. A switching unit according to any of the preceding claims, wherein said processor is also configured to prioritize packets of a predetermined type representative of prioritized handling forwarded to said another priority port from a data network port associated with said another priority port.

7. A switching unit according to any of the preceding claims, wherein if said processor can not determine said another priority port to which said packet of a predetermined type representative of prioritized handling arriving from said priority port is to be forwarded, said processor is configured to flood said packet to all said priority ports except said priority port at which said packet arrived.

8. A switching unit according to any of claims 1 to 6, wherein if said processor can not determine said another priority port to which said packet of a predetermined type representative of prioritized handling arriving from said priority port is to be forwarded, said processor is configured to forward said packet onto the data network port associated with said arriving priority port.

9. A switching unit according to any one of the preceding claims, said processor comprising:
(i) a first switch;
(ii) a second switch, connected to said first switch;
(iii) a third switch, connected to said first and said second switch; and
(iv) a number of demultiplexers, each connected to one of said priority ports and to said first switch and said second switch, each said demultiplexer being configured to forward a packet arriving at a priority port to said first switch on condition that said packet is of a predetermined type representative of prioritized handling and to said second switch on condition that said packet is of a type not representative of prioritized handling,
said first switch being operative to determine the destination address of said packet forwarded from said demultiplexers and forward said packet to a demultiplexer for forwarding to a priority port having the destination address, whilst
said second switch is operative to forward said packet to said third switch,
said third switch being operative to forward said packet to the associated data network port; said third switch being operative to forward a packet arriving at a data network data port to said first switch; said fist switch being operative to forward said packet to a multiplexer that is connected to the associated priority port, and therefrom to the associated priority port.

10. A switching unit according to claim 9, wherein said connection of said first switch, second switch and third switch is achieved by means of an internal high-speed bus/backbone linking between said first switch, second switch and third switch.

11. A switching unit according to claim 10, wherein said internal high-speed bus/backbone is extendable by linking said internal high-speed bus/backbone to an external link.

12. A data network comprising:
a switching unit including a number of data network I/O ports and a tile number of priority I/O ports, each data network port associated with a different priority port;
a number of terminals connected to said switching unit through at least part of said number of priority ports; and
at least one network switching device, including a plurality of I/O ports, wherein some of said plurality of switching device ports are connected to said data network ports, each to a different data network port,
wherein a packet of a predetermined type representative of prioritized handling arriving at said switching unit from a terminal which requires transfer to another terminal is transferred to said another terminal and is prioritized over packets of types not representative of prioritized handling which also require transfer to said another terminal, and
wherein a packet of a type not representative of prioritized handling arriving at said switching unit from a terminal is transferred to a network switching device whose switching device port is connected to the data network port associated with the priority port connected to said terminal, and
wherein a packet of any type arriving at said switching unit from a network switching device via a switching device port is transferred to a terminal connected to the priority port associated with the data network port which is connected to said switching device port.

13. The network of claim 12, further comprising another switching unit, wherein a priority port of said switching unit is connected directly to a priority port of said another switching unit by means of a link connection, and wherein a packet forwarded to said linked priority port of said switching unit from another port of said switching unit is transferred to said another switching unit via said link connection instead of to a terminal connected to said switching unit.

14. The network of claim 13, wherein said at least one network switching device is two Ethernet switches and said link connection is an existing link connection, said link connection disconnected from said two linked Ethernet switches and reconnected between said switching unit and said another switching unit.

15. The network of claim 12, further comprising another switching unit, wherein a priority port of said switching unit is linked indirectly to a priority port of said another switching unit via at least one router capable of prioritizing packets that are of a predetermined type representative of prioritized handling, and wherein a packet forwarded to said linked priority port of said switching unit from another port of said switching unit is transferred to said another switching unit via said at least one router instead of to a terminal connected to said switching unit.

16. A method for forwarding packets in a prioritized manner for use in a switching unit including a number of data network I/O ports and a like number of priority I/O ports, each data network port connectable to a network switching device external to said switching unit, each priority port associated with a different data network port and with all other priority ports, the method comprising:
determining whether a packet, arriving from outside the switching unit, arrived at a priority port or at a data network port;
processing said packet, having arrived at a priority port, to determine its type;
comparing the type of said packet, having arrived at a priority port, with a number of predetermined types representative of prioritized handling;
processing said packet, having arrived at a priority port, having one of said predetermined types, to determine its destination address;
forwarding said packet, having arrived at a priority port, having one of said predetermined types, having a destination address matching that of another priority port, to said another priority port, wherein said packet is prioritized over packets of types other than said predetermined types forwarded to said another port;
forwarding a packet, having arrived at a priority port, having a type other than said predetermined types to the associated data network port;
forwarding a packet, having arrived at a data network port, to the priority port associated with said data network port.

17. The method of claim 16, wherein the determination of packet type is performed in dependence on the content of said packet

18. The method of claim 16, wherein the determination of packet type is performed in dependence on settings within a header portion of said packet.

19. The method according to claim 16, further comprising the step of:
forwarding said packet having arrived at a priority port, having one of said predetermined types, and not having a destination address matching that of a priority port to all of said priority ports, except to said priority port from which said packet arrived.

20. The method according to claim 16, further comprising the step of:
forwarding said packet having arrived at a priority port, having one of said predetermined types, and not having a destination address matching that of a priority port onto the associated data network port.

21. A computer program comprising computer program code means for performing all the steps of any of claims 16 to 20 when said program is run on a computer.

22. A computer program as claimed in claim 21 embodied on a computer readable medium.
